(19) United States
(12) Patent Application Publication
(10) Pub. No.: US 2008/0030610 A1
(43) Pub. Date: Feb. 7, 2008

(54) Lens adapted to image capturing apparatus

(75) Inventors: Yung Cheng Lai, Taipei (TW); Yung Wei Chang, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 11/882,418

(22) Filed: Aug. 1, 2007

(30) Foreign Application Priority Data
Aug. 2, 2006 (TW) 095128237

(51) Int. Cl. G02B 13/16

(52) U.S. Cl. 348/335; 348/E05.024

(57) ABSTRACT

The invention is to provide a lens adapted to an image capturing apparatus. In particular, the lens according to the invention is capable of reducing the divergence of radiation-based signals emitted from the interior of the image capturing apparatus.

### BACKGROUND OF THE INVENTION

1. Field of the Invention

The invention relates to a lens adapted to an image capturing apparatus. In particular, the lens according to the invention is capable of reducing the divergence of radiation-based signals emitted from the interior of the image capturing apparatus.

2. Description of the Prior A2rt

When an image capturing unit of an image capturing apparatus is rotated to a position below the boundary between a bubble sphere and a cylindrical curve, a part of infrared light passes through an infrared lens and causes light diffusion. When the diffused light passes through the bubble again, a part of the diffused light is reflected and enters the image capturing range to bring about an overexposure of the captured image.

In prior arts, two methods are provided to solve the above-mentioned problems. The first method is to reduce the light diffusing area by hollowing out the portion of the infrared lens which does not cover the infrared transmitter. The second method is to use the opaque material on the portion of the infrared lens which does not cover the infrared transmitter, and use the lucent material on the portion of the infrared lens which covers the infrared transmitter.

However, although both methods reduce the light diffusing area, the first method affects the appearance of the infrared lens and the second method causes the cost of the mold increase.

Therefore, the main scope of the invention is to provide a lens adapted to an image capturing apparatus, and the area of the lens which not covers the radiation-based signal transmitter is coated a layer of the radiation-based signal absorbing material to reduce the light diffusing area. The invention will not change the appearance of the lens and will not increase the cost by using special-made mold.

### SUMMARY OF THE INVENTION

A scope of the invention is to provide a lens adapted to an image capturing apparatus. The image capturing apparatus comprises at least one radiation-based signal transmitter and an image capturing unit.

According to a preferred embodiment, the lens of the invention comprises a lens body and a radiation-based signal absorbing material. The lens body thereon has an inner surface and an outer surface opposite to the inner surface. The inner surface faces the at least one radiation-based signal transmitter and the image capturing unit. The lens body thereon has an opening. The opening faces the image capturing unit. The radiation-based signal absorbing material is coated over a portion of the inner surface. The portion of the inner surface does not face the at least one radiation-based signal transmitter.

The advantage and spirit of the invention may be understood by the following recitations together with the appended drawings.

### BRIEF DESCRIPTION OF THE APPENDED DRAWINGS

FIG. 1 is a lateral view of an image capturing apparatus adapting a lens of a preferred embodiment according to the invention.

FIG. 2 is a front view of a lens of a preferred embodiment according to the invention.

FIG. 3A shows an image captured by an image capturing apparatus using a general infrared lens.

FIG. 3B shows an image captured by an image capturing apparatus using an infrared lens in a preferred embodiment according to the invention.

### DETAILED DESCRIPTION OF THE INVENTION

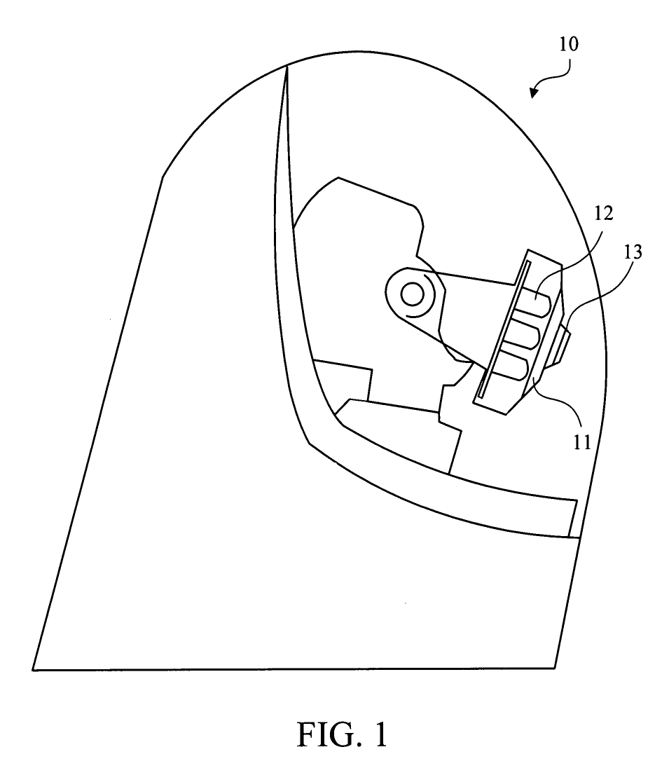

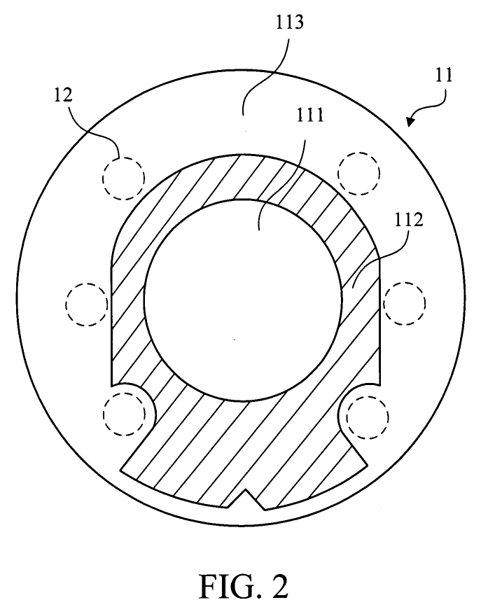

Please refer to FIG. 1 and FIG. 2. FIG. 1 is a lateral view of the image capturing apparatus adapting a lens of a preferred embodiment according to the invention. FIG. 2 is a front view of a lens of a preferred embodiment according to the invention.

As shown in FIG. 1 and FIG. 2, a lens 11 of a preferred embodiment according to the invention is adapted to an image capturing apparatus 10. The image capturing apparatus 10 comprises at least one radiation-based signal transmitter 12 and an image capturing unit 13. FIG. 1 shows three radiation-based signal transmitters 12 as an example.

The lens 11 comprises a lens body 113 and a radiation-based signal absorbing material 112.

The lens body 113 thereon has an inner surface and an outer surface opposite to the inner surface. The inner surface faces the at least one radiation-based signal transmitter 12 and the image capturing unit 13. The lens body 113 thereon has an opening 111. The opening 111 faces the image capturing unit 13.

The radiation-based signal absorbing material 112 is coated over a portion of the inner surface. The portion of the inner surface does not face the at least one radiation-based signal transmitter 12. FIG. 2 shows a coating pattern of the radiation-based signal absorbing material 112. However, the coating pattern in practical applications is not limited by this example.

In an embodiment, the coating of the radiation-based signal absorbing material 112 is performed by a transfer printing process.

In an embodiment, each of the at least one radiation-based signal transmitter 12 is an infrared transmitter.

In an embodiment, the radiation-based signal absorbing material 112 is a paint with capability of absorbing infrared light transmitted by the at least one infrared transmitter, for example, a dull black paint.

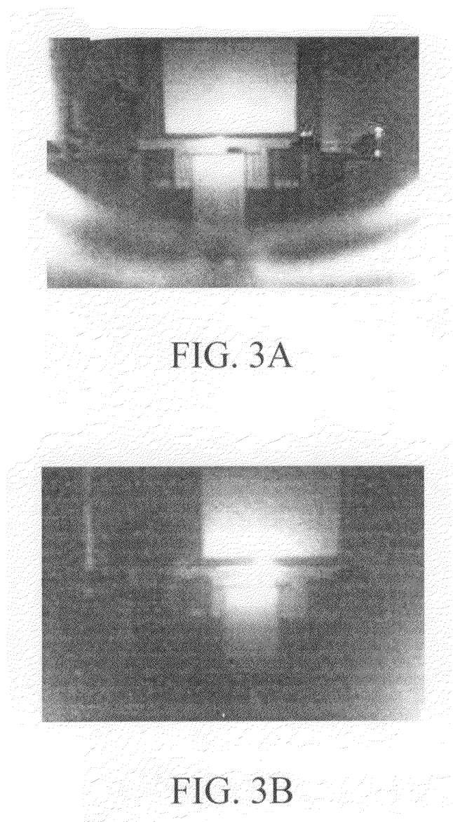

In practical applications, a lens of a preferred embodiment according to the invention is adapted to an image capturing apparatus. When a radiation-based signal is emitted by the radiation-based signal transmitter, the radiation-based signal can not pass through the radiation-based signal absorbing material. Thus, the probability of the radiation-based signal reflecting through the bubble and enters the image capturing range to bring about an overexposure of the captured image is decreased. Please refer to FIG. 3A and FIG. 3B. FIG. 3A shows an image captured by an image capturing apparatus using a general infrared lens. FIG. 3B shows an image captured by another image capturing apparatus using an infrared lens of a preferred embodiment according to the invention. An overexposure occurs at the under side of the image in FIG. 3A. Contrarily, one can obviously observe that the exposure of the image is improved in FIG. 3B.

Compared to the prior arts, a lens of a preferred embodiment according to the invention will not change the appearance of the lens and increase the cost because no special-made mold is used in the present invention. The area of the lens which does not cover the radiation-based signal transmitter is coated a layer of the radiation-based signal absorbing material to reduce the light diffusing area. Therefore, the probability that the radiation-based signal is reflected through the bubble and enters the image capturing range to cause an overexposure of the captured image is decreased.

With the above example and explanation, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A lens adapted to an image capturing apparatus comprising at least one radiation-based signal transmitter and an image capturing unit, said lens comprising:
a lens body thereon having an inner surface, facing the at least one radiation-based signal transmitter and the image capturing unit, and an outer surface opposite to the inner surface, the lens body thereon having an opening facing the image capturing unit; and
a radiation-based signal absorbing material, coated over a portion of the inner surface which does not face the at least one radiation-based signal transmitter.

2. The lens of claim 1, wherein each of the at least one radiation-based signal transmitter is an infrared transmitter.

3. The lens of claim 2, wherein the radiation-based signal absorbing material is a paint with capability of absorbing infrared light transmitted by the at least one infrared transmitter.

4. The lens of claim 1, wherein the coating of the radiation-based signal absorbing material is performed by a transfer printing process.
